(19) United States
(12) Patent Application Publication
(10) Pub. No.: US 2014/0079894 A1
(43) Pub. Date: Mar. 20, 2014

(54) MULTILAYER ARTICLE HAVING COLD SEAL COATINGS

(71) Applicant: Sihl GmbH, Duren (DE)

(72) Inventors: Elisabeth Buchbinder, Nideggen (DE); Axel Niemöller, Duren Niederau (DE)

(73) Assignee: Sihl GmbH, Duren (DE)

(21) Appl. No.: 14/028,973

(22) Filed: Sep. 17, 2013

Related U.S. Application Data
(60) Provisional application No. 61/702,135, filed on Sep. 17, 2012.

(51) Int. Cl. G09F 3/02; B32B 33/00; B32B 7/12; G09F 3/10; B32B 38/00; B32B 7/02

(52) U.S. Cl. CPC G09F 3/02; B32B 38/0012; B32B 7/02; B32B 7/12; G09F 3/10; B32B 33/00
USPC 428/32.11; 156/227; 428/78; 428/32.39; 428/41.8; 428/34.1

(57) ABSTRACT

The present invention relates to a multilayer article comprising a first substrate with a first backing layer and comprising at least one further (second) substrate with a second backing layer, where these have been provided on respectively one side at least to some extent with a cold-seal adhesive layer and have been bonded to one another specifically via the contact between their respective cold-seal adhesive layers, to a process for the production of an article of this type, and also to the use of a printer with at least two unwind systems and with at least one cutting device for the production of articles of this type.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

1. Field of the Invention

The present invention relates to a multilayer article comprising a first substrate with a first backing layer and comprising at least one further (second) substrate with a second backing layer, where these have been provided on respectively one side at least to some extent with a cold-seal adhesive layer and have been bonded to one another specifically via the contact between their respective cold-seal adhesive layers, to a process for the production of an article of this type, and also to the use of a printer with at least two unwind systems and with at least one cutting device for the production of articles of this type. In particular, the present invention also relates to the cost-optimized production of a baggage-tag strip with what is known as a RFID transponder (Radio-Frequency-Identification/identification with the aid of electromagnetic waves), in particular for self-check-in available on demand to the end-consumer (on demand print during self-check-in).

2. Description of the Related Art

Many fields of technology store and communicate information by using labels which can be attached on an object that requires identification marking. In the simplest case, a label is composed of a backing substrate on or in which the information to be stored and/or to be communicated is held, an example being a piece of paper on which writing can be entered, and a device for attaching the label on the goods, an example being a self-adhesive coating on the underside of the backing substrate, i.e. on the side opposite to the side bearing information, or a loop which can be used to secure the label on the object requiring identification. In order that data acquisition and identification can be automatic, i.e. carried out by a machine, there may be by way of example what are known as barcodes printed onto the upper side/frontal side of the labels. Contactless data acquisition even through intervening materials can be achieved by what are known as RFID systems, where an active or passive transponder, comprising at least one chip and at least one antenna, within the electromagnetic field of a reader device, can transmit and optionally also receive data. Another term sometimes used in informal speech for labels with an RFID transponder is “radio tags”.

### SUMMARY OF THE INVENTION

Because in practice operations on an object provided with a label are often carried out at a plurality of locations, where both manual and automatic information processing often takes place, and the latter sometimes indeed uses different systems at the different locations, there is a need to combine different types of data storage and of data communication in labels which moreover should preferably be amenable to low-cost environmentally friendly production.

This is described hereinafter mainly by taking the example of baggage-tag strips, in particular those for the identification of items of baggage in air travel (another term used hereinafter being airline baggage tags); however, the present invention is not restricted to that application. The subject matter of the present invention can by way of example also be used as loop tags for the identification of articles which are not items of baggage, for example in the field of logistics.

Airline baggage tags are usually elongate multilayer strips made of flexible materials which always have information applied by printing on one side thereof. These tags are usually wrapped around a handle or the like on the item of baggage to be identified, whereupon the unprinted sides of the two ends of the tag are then secured to one another with an adhesive. Airline baggage tags generally also have control sections which are detachable from the tag and are known by way of example as additional stubs or claim tags.

On the visible side there is printed information relevant to the transport of the item of baggage, permitting automatic allocation and sorting of the baggage on the basis of its intended destination and mainly taking the form of a barcode. However, it has been found that, in particular in the case of transfer flights, i.e. flights with an intermediate stop, where the bag has to be reloaded from one aircraft into another, the reloading of the luggage frequently causes creasing of the baggage tag, thus impairing the readability of the printed barcode. At the transfer airport it is usually necessary to repeat the reading of the barcode, in order to ensure correct allocation of the item of baggage in the short time available, and specifically in the case of transfer flights there is therefore a comparatively large number of items of baggage that cannot be correctly allocated or at least cannot be correctly allocated to their intended destination within the time available.

RFID labels, as described by way of example in EP 1 035 504 A1, are in contrast substantially more resistant to adverse environmental conditions, such as dirty, moist and wet conditions, and moreover do not require clear visibility of the data carrier or code carrier; in contrast, their signals can even penetrate a variety of materials—with the exception of metal. The readability of a RFID transponder is also impaired to a lesser extent by the stress to which the airline baggage tag is subjected during manual reloading of items of baggage.

The incorporation of RFID tags is currently carried out in an additional separate operation during the production of the airline baggage tags, i.e. not “on demand” at the airport, and usually with the aid of dispensing machines for self-adhesive inlays and labels. A roll of the printed or unprinted label-backing material which has, on one side, a self-adhesive coating covered by a silicone backing material, and a roll of the part-punched inlays which likewise have, on one side, a self-adhesive coating itself likewise covered by a silicone backing material are bonded in a dispensing machine in such a way that the inlays are peeled from their silicone backing material and that their adhesive sides are applied to the reverse side of the label.

Airline baggage tags with an integrated RFID transponder alongside a barcode print on the frontal/upper side are described by way of example in EP 0 595 549 A2. However, since the incorporation of a RFID transponder into a baggage tag incurs additional costs, and for direct flights the reading rate for commercially available airline baggage tags with a barcode print without RFID tag is often adequate, there is a need for a suitable product structure and a process for producing same where it is possible—depending on requirement—to provide a “standard” airline baggage tag without integrated RFID transponder or an airline baggage tag with integrated RFID transponder; this should be achieved at minimum cost and in a manner that protects the environment, i.e. with avoidance of unnecessary waste products in the production process.

Surprisingly, this object is achieved via the multilayer article of the present invention and the process for production thereof, as in particular described in the claims. By use of cold-seal adhesive instead of the pressure-sensitive adhesive usually used, both for the coating of the underside of the first substrate (for example of the label) and of the second substrate (for example of an RFID transponder on a backing material/RFID inlay/RFID tag), it is possible to omit use of the release-agent-coated protective papers, for example silicone papers, usually used for the protective covering of self-adhesive layers (also termed pressure-sensitive-adhesive layers). This is advantageous for economic and environmental reasons. Labels of this type can also be produced by the process of the present invention in what are known as “on-demand” printers for self-check-in of airline passengers, where a label that has an RFID transponder is provided only if necessary, for example in the case of a transfer flight, whereas otherwise a conventional label without RFID transponder is dispensed.

This type of printer requires only two unwind systems, respectively one for the first substrate (for example label material) and one for the second substrate (for example RFID transponder inlay), but does not require either devices for separating a first or second substrate from a protective paper or winder systems to receive the protective paper. The printers used to provide the corresponding labels are also therefore less expensive to produce and purchase, and can be operated with less need for maintenance.

In loop-label applications, use of a cold-seal adhesive layer which adheres only on a coating of the same type (as it were “to itself”) moreover also avoids adhesive residues of any type on the items of baggage to be transported. Substrates coated with this type of adhesive can moreover also readily be printed by way of example by the thermal, thermal-transfer, ink-jet and matrix printing processes.

The present invention therefore provides a multilayer article comprising a first substrate with a first backing layer and comprising at least one further (second) substrate with a second backing layer, where these have been provided on respectively one side at least to some extent with a cold-seal adhesive layer and have been bonded to one another specifically via the contact between their respective cold-seal adhesive layers, where the area of the first substrate is greater than that of the at least one further substrate and the at least one further substrate only to some extent covers the cold-seal adhesive layer of the first substrate.

For the purposes of the present invention, a substrate comprises a multilayer structure (laminate) which comprises at least one backing layer and, on an outer surface, at least to some extent has a cold-seal adhesive layer, while its other surface opposite to said surface preferably has no cold-seal adhesive layer.

For the purposes of the present invention, the term backing layer is used for a layer which gives the multilayer article mechanical stability and/or tear resistance, for example a layer made of paper, of paper board, or of suitable polymer foils.

For the purposes of the present invention, multilayer means that the article has at least the two abovementioned substrates, where these in turn can mutually independently likewise respectively comprise a multilayer laminate. The first and/or the second backing layer can by way of example comprise the following product structure described in more detail in WO 00/55832 A1:
1. Layer comprising release agent (known as release layer)
2. Heat-sensitive coating
3. Paper
4. Lamination adhesive
5. Biaxially stretched foil
6. Lamination adhesive
7. Paper
8. Cold-seal adhesive

or else can have the following product structure described in more detail in EP 2 061 018 A1 and EP 2 431 962 A1:
1. Layer comprising release agent (known as release layer)
2. Heat-sensitive coating
3. Paper
4. Pressure-sensitive adhesive
5. Layer comprising release agent (known as release layer, preferably based on silicones)
6. Biaxially stretched foil
7. Cold-seal adhesive.

It is thus possible by way of example to produce airline baggage tags with what is known as a “piggyback” product structure, where these combine more than one functional layer in the structure of a composite, for example a self-adhesive layer and a cold-seal adhesive layer. In the use as airline baggage tags it is possible by way of example that the control sections (known as “additional stubs”) required for many airlines are punched out from the self-adhesive layer and secured on the control sheets provided for that purpose, while the adhesive bonding around a luggage handle can be achieved with the aid of the cold-seal adhesive layer, without any requirement for peeling off a silicone paper.

Substrates coated on one side with cold-seal adhesive are therefore in principle already known from the prior art, as also is the adhesive bonding of two ends of a substrate coated with a cold-seal adhesive.

However, the present invention provides, for the first time, an article and a process where a first substrate which has a certain area is bonded to one or more further substrates of smaller size by way of cold-seal adhesive layers, where the further substrate(s) only to some extent cover(s) the cold-seal adhesive layer(s) of the first substrate. This is particularly advantageous for what is known as “inserted inlay dispensing”.

The product structure of the first and of the at least one further substrate can be identical or different, but it is preferable that the second substrate comprises at least one chip for the storage of data and one antenna, preferably an RFID device. It is preferable that the first substrate comprises no such chip and no antenna.

It is particularly preferable that the second substrate comprises an RFID transponder as RFID device, comprising a chip and at least one antenna on a backing. Suitable RFID transponders are described by way of example in EP 1 035 503 A1 and EP 1 035 504 A1. It is possible in principle here to use active or passive RFID transponders, but preference is given to passive RFID transponders to which energy is supplied via the alternating magnetic fields or high-frequency radio waves generated by the reader device, and which do not themselves require any energy supply in the form of a battery or the like. The RFID transponders can have an operating frequency in what is known as the low-frequency range (<135 kHz, for example 128 kHz), high-frequency range (13.56 MHz), ultrahigh-frequency range (860-930 MHz, for example 868-915 MHz) and in the microwave range (2.45 GHz).

The backing layer of the first and/or of the at least one further substrate (hereinafter also termed first and/or second backing layer, although each of the substrates can comprise more than one backing layers differing from one another) is preferably one selected from the group consisting of paper, paper board, polymer foils, where the latter are preferably selected from the group consisting of cellulose acetate (CA), polyamide (PA), polycarbonate (PC), polyethylene (PE), polyethylene naphthalate (PEN), polyethylene terephthalate (PET), polyimide (PI), polylactic acid (PLA), polypropylene (PP), polystyrene (PS), and polyvinyl chloride (PVC), metallized foils, metal foils, and nonwovens, or (multilayer) laminates comprising these, where the individual layers of these laminates can respectively be composed of the same or different materials and can optionally have reinforcement by natural or synthetic fiber materials. To the extent that foils are used as backing layer or as constituent of a backing layer, these can mutually independently be unstretched or monoaxially or biaxially stretched foils. Particular preference is given to biaxially stretched foils, since they have good tear resistance even after lamination within the composite. Examples obtainable commercially are the biaxially oriented polyester films Mylar and Melinex, obtainable from DuPont/Teijin Films (Luxembourg).

The selection of the backing layers is generally such that preferably each of the substrates, but at least the multilayer article formed by bonding of a first substrate to at least one further substrate, has high mechanical strength, in particular high breaking load. It is preferable that the breaking load of any substrate in the multilayer article, for a width of 15 mm, in accordance with ISO 1924-1:1992(E) after 24 hours of conditioning of the substrates at 23° C. and 50% relative humidity is about 40 to 3000 N/15 mm, more preferably 100 to 2500 N/15 mm, and particularly preferably 120 to 500 N/15 mm, not only in machine direction (MD) but also perpendicularly thereto (CD), where in the case of a multilayer article for the purposes of the present invention the individual layers preferably have the same orientation. The length of the test strips used in the measurement is 250 mm. To the extent that biaxially oriented polymer films are used, it is possible to aim at high (initial) tear resistance, whereas tear-propagation resistance can sometimes be low. When monoaxially oriented polymer films are used, high tear resistance is generally obtained only perpendicularly to said orientation. When unoriented polymer films are used, it is generally possible to obtain not only good (initial) tear resistance but also good tear-propagation resistance.

It is preferable that the tear resistance of any substrate in cross direction (CD) in accordance with ASTM D-1004-07 is above 25 N, particularly above 30 N, and it is preferably at most 100 N, measured with a M5K tensile tester from Ametek (Merbusch, Germany) with a specimen of thickness 100-300 μm, in particular 200 μm.

The thickness of the backing layers is preferably in the range 3 to 250 μm, with preference 9 to 100 μm, and in particular 12 to 80 μm. If the backing layer comprises paper or paper board, its weight per unit area is preferably 30 to 250 g/m², more preferably 40 to 200 g/m², and in particular 50 to 150 g/m².

Cold-seal adhesives (other English-language terms used being cold seal and cohesive seal) are specific types of adhesives which exhibit significant adhesion to themselves, i.e. to cold-seal adhesives, at room temperature solely by virtue of pressure without means of activation such as heat or water or other solvents, whereas they in essence exhibit no adhesive properties in relation to other substrates. The initial adhesion (loop-tack) of a commercially available satinized paper of weight per unit area 80 g/m² coated with 7 g/m² of a cold-seal adhesive for the purposes of the present invention, dried at 60° C. for 4 minutes and conditioned at 23° C. and 50% relative humidity for 24 hours prior to testing is preferably less than 0.3 N in relation to a sheet of float glass in accordance with FTM 9. There is therefore no need for protected covering of cold-seal adhesive layers with a protective paper in order to prevent undesired adhesive bonding to other substrates; this saves costs and resources and in many cases also simplifies manual handling and handling in machines. Suitable cold-seal adhesives are known to the person skilled in the art. It is preferable that the cold-seal adhesive layers mutually independently respectively comprise at least one cold-seal adhesive selected from the group consisting of naturally occurring or synthetic latex, naturally occurring or synthetic rubber, (meth)acrylate copolymers, and mixtures of these. An example of a producer of suitable cold-seal adhesives is Henkel, registered in Düsseldorf (trade name Latiseal).

Cold-seal adhesive layers are preferably produced by applying mixtures of naturally occurring or synthetic latex dispersions and/or applying aqueous polyacrylic acid dispersions, polyacrylate dispersions, poly(meth)acrylate dispersions and/or acrylate-(meth)acrylate copolymer dispersions or a mixture of these (meth)acrylate dispersions to one side of the respective backing layer which, in order to improve the adhesion of the cold-seal adhesive layer, can optionally have been pretreated, and then drying.

A typical example of a cold-seal adhesive layer composition comprises 40 to 65% by weight, preferably 50 to 60% by weight, of a natural latex dispersion, preferably adjusted to pH about 10 via addition of ammonia, 20 to 50% by weight, preferably 30 to 40% by weight, of a styrene-acrylate emulsion or styrene-acrylate dispersion, and a small proportion, usually a total proportion of 1 to 5% by weight, based on the composition, of components selected from wetting agents, latex stabilizers, antioxidants, biocides, thickeners and/or substances for increasing tack (known as tackifiers).

Suitable examples of cold-seal adhesives based on naturally occurring latex dispersions and on aqueous polyacrylate dispersions are described by way of example in U.S. Pat. No. 5,070,164, U.S. Pat. No. 4,898,787, and U.S. Pat. No. 4,888,395.

The cold-seal adhesive layer is usually applied with a weight per unit area in the range of about 2 to 25 g/m², preferably of about 4 to 15 g/m², based on dry mass.

Adhesion (180° peel resistance at room temperature/23° C.) by a method based on FTM 1 of FINAT (Federation Internationale des Fabricants et Transformateurs dé Adhesives et Thermocollants sur Papiers et autre Supports), measured 3 minutes after two surfaces coated with the cold-seal adhesive have been brought into contact with one another, is usually at least 3 N/25 mm, preferably at least 5 N/25 mm, and at most 30 N/25 mm. Since adhesion is measured here for two substrates coated with cold-seal adhesive in relation to one another, one of the substrates is by way of example fixed with double-sided adhesive tape on a V2A steel plate in such a way that the cold-seal-adhesive-coated side is uncovered above the steel plate and can then be adhesive-bonded to the second substrate. In other respects, the method follows FTM 1.

It is preferable that adhesion between the cold-seal adhesive layers is sufficiently high that excessive loading tears the backing substrate, but without any adhesive or cohesive fracture of the adhesive layer, in particular if a backing layer made of paper is used.

The cold-seal adhesive layers can cover the relevant surface of the respective backing layer completely or partially. A coating that is only partial can in particular be advantageous for reasons of cost. It is possible to apply the cold-seal adhesive layer by way of example in strips, preferably in the longitudinal direction, i.e. in the direction of greater longitudinal extent of the respective substrates. However, other application patterns are also conceivable. Since the final use requires the cold-seal adhesive layer only in those regions that are intended to make contact with another cold-seal adhesive layer, these are also the only regions that must be coated with this cold-seal adhesive layer. In particular in the particularly preferred embodiment of the invention in which the first substrate represents an airline baggage tag bonded to a second substrate comprising a chip, preferably an RFID transponder, the first substrate can advantageously be coated with cold-seal adhesive only in those regions of the one side of its backing layer that are needed in the use as airline baggage tag for the adhesive bonding of the two ends of the baggage tag on an item of baggage, and also (where appropriate additionally) in the region in which said first substrate is adhesive-bonded to the second substrate.

Processes for the application of the cold-seal adhesive layers to the backing layers are known to the person skilled in the art and comprise conventional coating techniques, such as roll coating, roller-doctor spreading, die application, and intaglio printing. In particular for a cold-seal-adhesive-layer coating that is only partial on a backing layer, preference is given to application by means of a die technique or intaglio printing technique.

At least one side of one of the substrates, or of both substrates, comprises at least to some extent a writable and/or printable surface, preferably a surface that is printable by means of a process selected from the group consisting of thermal printing, in particular direct thermal printing and thermal transfer printing, ink-jet printing, transfer printing, laser printing, offset printing, flexographic printing, intaglio printing, and screen printing.

It is preferable that the outer surface that is opposite to the cold-seal adhesive layer in the first substrate is writable and/or printable. In the final use of the particularly preferred embodiment of the invention, of an airline baggage tag attached in loop form around the grip or similar of an item of baggage, this side is the visible side, and it is therefore hereinafter also termed upper side of the multilayer article. This upper side can be a backing layer which is printable without any further additional printable layers, an example being a backing layer made of paper, of paper laminates, of paper board, of printable polymer films, or of nonwovens, an example being the commercially available product Tyvek from DuPont (Luxembourg). As an alternative or in addition it is also possible that one or more printable layers has/have been applied to the first backing layer, examples being heat-sensitive layers for thermal printing, ink-absorbing layers, heat-absorbing layers for thermal transfer printing, laser-printable layers, layers printable by means of offset processes, and layers printable by flexographic printing.

Suitable coating compositions, and also processes for application thereof to backing layers, are known to the person skilled in the art. Particular preference is given to layers which are printable by thermal printing and by thermal transfer printing and which can comprise, in addition to the heat-sensitive layer, further layers above that layer. By way of example, above the heat-sensitive layer it is also possible to use a layer with release properties (known as release layer) thereabove, which is described in more detail hereinafter. Papers and coatings suitable for thermal printing are described by way of example in U.S. Pat. No. 5,811,368 and in the documents cited therein.

In particular when the second substrate comprises an RFID transponder which is attached on an airline baggage tag, use of a printable layer in the second substrate can be omitted.

At least one of the substrates of the present invention, preferably the first substrate, can also comprise a multilayer laminate which comprises a layer comprising release agent (release layer). This can be the outermost layer on the surface opposite to the cold-seal adhesive layer in the first substrate (on the frontal side in the preferred embodiment of the airline baggage tag with RFID transponder)—as already described above—but can also be a layer within the substrate; in that case the location of the layer comprising release agent is not at the surface of the substrate but instead in its interior, and there are also other layers above and below said layer. The substrate can also comprise a plurality of these layers comprising release agent, for example not only a surface layer comprising release agent but also at least one such layer in the interior of the substrate.

To the extent that one of the substrates comprises a layer comprising release agent within the interior of the substrate, i.e. a layer which is not at one of the two surfaces of a multilayer laminate, it is preferable that this layer comprising release agent is in contact with a self-adhesive layer. It is thus possible to realise what is known as a “piggyback” structure, which has already been described above. With this type of structure it is possible through selective punch-out to produce self-adhesive labels which can be peeled from the multilayer article and can be adhesive-bonded to any desired substrates. In this way it is possible by way of example to produce the “additional stubs” required by many airlines. Reference may be made to EP 2 061 018 A1 for further details.

The application of a layer comprising release agent to the surface of the frontal side of the first substrate can reduce the adhesive effect, on said frontal side, of the cold-seal adhesive layer applied to the reverse side of the substrate, in particular if the first substrate, or else the multilayer article which is provided by the present invention and which has been formed with use of this first substrate, takes the form of a wound-up roll; it thus reduces the force that has to be exerted during unrolling of the material.

This optional layer comprising release agent can by way of example be produced via application of a composition comprising an organic release agent selected from the group consisting of polyamides, amide waxes, montan waxes, polyolefin waxes, ester waxes, calcium stearate, zinc stearate, polyvinyl ester, polyacrylate copolymers, fatty acid esters, polysaccharides, polysiloxanes, and long-chain alkyl products, which for the purposes of the present invention means monomeric or in particular polymeric compounds comprising one or more alkyl moieties with chain length ≧12 carbon atoms, preferably 13 to 30 carbon atoms, examples being poly(meth)acrylates having alkyl side chains having from 16 to 20 carbon atoms and mixtures of these.

The force required to separate a cold-seal adhesive layer on the reverse side/underside of a substrate or multilayer article from the surface on the opposite side/frontal side of this substrate or multilayer article, measured in accordance with FTM 3, where the side not coated with the cold-seal adhesive in a substrate is separated from the side coated with the cold-seal adhesive in an identical substrate, is preferably at most 300 cN/50 mm, more preferably at most 200 cN/50 mm, and particularly preferably 100 cN/50 mm. It is preferable that this force, which characterizes the unwinding behavior of the material from a roll during the processing/the printing of the label, is as small as possible, usually however being above 30 cN/50 mm.

The optionally present self-adhesive layer in the interior of a multilayer laminate, i.e. in the interior of a substrate, can take the form of permanent or peelable self-adhesive layer. Permanent pressure-sensitive adhesives for the purposes of the present invention generally have adhesion, measured in accordance with FTM1 after a contact time of 24 hours, of 16-30 N/25 mm, whereas peelable adhesives have adhesion of 4-12 N/25 mm. In order to permit removal of this layer (inclusive of any likewise punched-out layers situated thereabove) from the multilayer laminate and leave no residue, there is a further layer provided comprising release agent, hereinafter termed “inner layer comprising release agent” under the former layer—if that is present. This type of inner layer comprising release agent usually comprises a polysiloxane compound, and can be adapted appropriately by the methods known to the person skilled in the art for a desired adhesion on the self-adhesive layer. The separation force that has to be exerted to separate the self-adhesive layer from the inner layer directly adjacent thereto comprising release agent, measured in accordance with FTM 3, is preferably 10 cN/50 mm to 300 cN/50 mm. Suitable pressure-sensitive adhesives are known to the person skilled in the art and can by way of example comprise acrylic or vinyl acetate polymers and/or the corresponding copolymers or a mixture of these. These adhesives can be based on water or on organic solvents. As an alternative, it is also possible to use hot-melt adhesives, for example those based on thermoplastic elastomers, or to use acrylates that harden on exposure to UV radiation. To the extent that the pressure-sensitive-adhesive layer is used, its weight per unit area is usually in the range of 3 to 50 g/m², preferably 10 to 25 g/m², based on dry mass.

The pressure-sensitive-adhesive layer, too, can be applied by the conventional coating processes known to the person skilled in the art, for example by the roll coating process, roller-doctor spreading process, or intaglio printing process, or by means of curtain coating or die coating, for dispersions and solvent-containing systems, or by the roll spreading process, curtain process, or die process for hot-melt adhesives.

It is preferable that the multilayer article of the present invention but as well as each of its substrates is flexible, i.e. their stiffness is preferably in the range >0 and <65 mN for the individual substrates and in the range 5 to 65 mN for the multilayer article, in each case measured in accordance with ISO 2493-1:2010(E) after 24 hours of conditioning of the specimens at 23° C. and 50% relative humidity in the transverse direction (CD) with a bending length of 50 mm. In the case of values obtained here that are below 20 mN, stiffness for a shorter bending length of 10 mm should be within the range 30 to 300 mN in accordance with ISO 2493-1:2010(E).

As previously stated, in one particularly preferred embodiment the multilayer article of the present invention is an airline baggage tag with integrated RFID transponder which can be wound in the form of a loop around a handle, or the like, of an item of baggage and which can be attached thereon via adhesive bonding of the two ends of the tag by way of their cold-seal adhesive layers.

It is therefore preferable that the first substrate of the multilayer article of the present invention has been arranged at least to some extent in the manner of a loop in a manner such that a first region of the cold-seal adhesive layer of the first substrate has been adhesive-bonded to a further region of the cold-seal adhesive layer of said first substrate, where the location of the second substrate can be outside of, to some extent within, or completely within said adhesive-bonded region of the two ends of the first substrate, where the article is preferably a label (loop tag) attached on the object requiring identification marking, and is particularly preferably a label attached in the manner of a loop in the form of a baggage-tag strip on an item of baggage.

The second substrate, which by way of example can comprise a security feature and/or a data-storage device, preferably an RFID transponder, can therefore have been introduced outside of, partially within, or completely within the adhesive bond between the two ends of the first substrate by way of their cold-seal adhesive layer. Surprisingly, it has been found that the adhesion of an airline baggage tag is not significantly impaired by attaching an RFID transponder in its interior, although there is a marked resultant reduction in the adhesive-bonded area. The examples hereinafter provide a more detailed illustration of this.

It is preferable that the shape of the first substrate is in essence rectangular and elongate. For the purposes of the present invention, the expression “in essence rectangular” also includes the presence of one or more rounded or bevelled corners, a certain amount of appropriate adjustment of the shape of the substrate, or the like. In particular prior to the bonding to the second substrate, the first substrate can preferably be provided in the form of a roll of any desired length. For the end use of the multilayer article of the present invention, however, the length of the first substrate is preferably 150 to 800 mm, more preferably 300 to 700 mm, and particularly preferably 400 to 600 mm. The width of the first substrate is preferably 15 to 80 mm, more preferably 30 to 70 mm, and particularly preferably 45 to 60 mm.

The second substrate can in principle assume any desired shape and by way of example can be in essence square, rectangular, hexagonal, round, oval, or of irregular shape, without any restriction thereto. The length data hereinafter therefore refer to the diameter of the substrate or the greatest longitudinal dimension. The length of the second substrate is preferably 10 to 100 mm, more preferably 15 to 75 mm, and particularly preferably 20 to 50 mm. The width of the second substrate is preferably 10 to 75 mm, more preferably 15 to 50 mm, and particularly preferably 20 to 40 mm.

In comparison with the first substrate, the second substrate is always shorter, i.e. has a smaller longitudinal dimension, and preferably also narrower, i.e. of smaller width. The length of the second substrate is preferably at most 50 percent of the length of the first substrate, particularly preferably at most 20 percent of the length of the first substrate, and at least 2 percent of the length of the first substrate. This ensures that when the second substrate is attached the adhesive-bonding area required on the first substrate for the final use as loop tag is available. To the extent that the second substrate has been attached within the region (not adhesive-bonded to any other part of the first substrate) of the loop of the baggage tag, it is also possible that the second substrate has the same width as the first substrate. However, in particular when the second substrate has been introduced in the region in which, in the end use, two ends of the first substrate are adhesive-bonded to one another, the second substrate should also be narrower than the first substrate. The width of the second substrate should preferably be at most 90 percent, and at least 10 percent, particularly preferably 40-60 percent, of the width of the first substrate, in order to ensure adequate adhesion of the adhesive-bonding areas between the two ends of the first substrate.

The present invention also provides a process for the production of the article of the invention, comprising the following steps:
i. separate provision of the first substrate and of the second substrate,
ii. optional cutting-to-size and/or segmenting of the first and/or of the second substrate,
iii. positioning of the second substrate relative to the first substrate in a manner such that the respective sides that have the cold-seal adhesive layer on the two substrates face each other, and
iv. exertion of a pressure on the arrangement obtained in step iii from the two substrates, in order to bond these to one another by way of their cold-seal adhesive layers.

The separate provision of the first substrate and of the second substrate can by way of example be achieved in the form of rolls on two different unwind systems of a thermal printer.

By way of example, a roll of the second substrate in the form of RFID tags coated with a cold-seal adhesive can be inserted into a second unwind system of a thermal printer alongside, located in a first unwind system of the same thermal printer, the baggage tag labels with a product structure corresponding to WO 00/55832 A1 or EP 2 061 018 A1. By way of an appropriate material-guide system, the two substrates are brought together, and specifically in such a way that the cold-seal adhesive layer of the baggage tag labels encounters the cold-seal adhesive layer of the RFID tags, thus permitting adhesive bonding of the baggage tag labels to the RFID transponders. By way of the printer software it is possible to drive unwind system one and two separately in such a way as to permit reproducibly defined positioning of the RFID tag on the baggage tag label. A blade attached within the printer after the second unwind system separates the RFID tag to be adhesive-bonded from the remaining RFID tags, and adhesive bonding on the reverse side of the baggage tag labels can take place. When a printed label is requested, the command issued within the printer can then be to print a baggage tag label with either RFID tag or without RFID tag. When a baggage tag label with RFID tag is requested, the RFID tag can be applied by adhesive bonding during print-out of the tag in the manner described immediately above by way of the second unwind system, onto the position to be defined via the software. Once print-out has ended, the finished, printed baggage tag label with RFID transponder applied by adhesive bonding can be detached by manual tearing by way of a perforation, if present, or detached by cutting by way of a second cutting device, which can be either outside or within the printer or immediately at the output end of the printer, i.e. the boundary between the interior of the printer and its exterior surroundings.

The process according to the invention can further comprise at least one step of writing and/or printing onto at least one part of the surface of the first and second substrate, preferably one part of that surface of the first and/or second substrate that is opposite to the cold-seal adhesive layer, particularly preferably by means of a process selected from the group consisting of thermal printing, ink-jet printing, transfer printing, laser printing, offset printing, flexographic printing, intaglio printing, and screen printing, prior to or after the bonding of the at least two substrates according to step iv. It is particularly preferable to print exclusively the frontal side of the first substrate.

As mentioned above, the first substrate and/or the second substrate can respectively be provided in the form of a web on a roll, where the substrate webs can mutually independently optionally have perforations. This is preferably achieved within a printer which comprises at least two unwind systems and at least one cutting device, particularly preferably within a printer comprising at least two unwind systems and, located within the printer, a cutting device (internal) for the cutting to detach, and the dispensing to insert, the RFID tag, and another cutting device for the cutting to detach the finished self-check-in airline baggage tags, i.e. self-check-in airline baggage tags optionally having an RFID tag, where the printer is preferably a thermal printer.

The invention further provides the use of a printer which comprises at least two, and preferably precisely two, unwind systems and at least one internal cutting device for the cutting to detach, and the dispensing to insert, the RFID tags, for the production of the multilayer articles of the invention. The multilayer article of the invention here is preferably a label, particularly preferably a label to be attached in the manner of a loop on an item of baggage and taking the form of a baggage-tag strip, as already described in detail above.

It is particularly preferable that the printer described above is used here for the production of the article of the invention by the process described above of the invention. Very particular preference is given to the use in self-check-in, in particular by airline passengers at an airport, where the printer is preferably a thermal printer.

### DESCRIPTION OF THE DRAWINGS

FIG. 1 illustrates the fundamental structure of the multilayer article of the present invention, where a first substrate 1 comprising a backing layer 5 which here has one side completely covered with a cold-seal adhesive layer 3 has been bonded to a second substrate 2 comprising a second backing layer 6 which here has one side likewise completely coated with a cold-seal adhesive layer 4, specifically by virtue of the contact between the two cold-seal adhesive layers 3 and 4. It can be seen that the area of the first substrate 1 is greater than that of the second substrate 2 and that the second substrate 2 only partially covers the cold-seal adhesive layer 3 of the first substrate 1. The substrates 1 and 2 can, in their simplest form, comprise only one backing layer 5 and, respectively, 6 alongside a cold-seal adhesive layer 3 and, respectively, 4, or can preferably have a plurality of layers, as illustrated by FIGS. 2 to 4 below.

FIG. 2 shows by way of example a multilayer structure which can be used for the first substrate 1 and/or the second substrate 2. This substrate comprises two backing layers 5a and 5b, bonded to one another in a multilayer laminate. The underside of one of the backing layers 5b has been coated with a cold-seal adhesive layer 3, whereas a layer 7 comprising release agent has been applied to the upper side of this backing layer 5b. On top of the layer 7 a second substrate 5a has been applied, which on its underside has a self-adhesive layer 9 which adheres on the release-agent layer 7. Broken lines depict punched locations; by virtue of these, parts of the upper backing layer 5a, and also of the self-adhesive coating 9 applied on the underside thereof, can be detached from the entire composite and by way of example can be used as self-adhesive control labels.

FIG. 3 shows another example of a structure of a multilayer laminate which can be used for the first and/or the second substrate and which also comprises, in addition to the features already described in FIG. 2, an additional printable layer 8 which has been applied to the upper backing layer 5a and the surface of which has in turn been coated with a coating 7a comprising release agent. Since the coating 7a comprising release agent is intended to facilitate the separation of this surface from the cold-seal adhesive layer 3, whereas the layer 7b comprising release agent is intended to allow adequate adhesion, but also separation from the self-adhesive layer 9, it is preferable that the compositions of these two layers differ. It can moreover be seen that here again punched locations optionally present comprise the upper layer 7a comprising release agent and also the additional printable layer 8.

FIG. 4 shows another embodiment of a multilayer substrate as already shown in principle in FIG. 3, where the backing layer 5b in this example is a three-fold composite.

FIG. 5 shows a plan view of a multilayer article of the present invention where the second substrate 2 has been introduced into an inner region of the longitudinal extent of the first substrate. The plan view shows the reverse side of the first substrate 1, said reverse side having being coated over its entire area with a cold-seal adhesive layer 3 (depicted by a dotted area).

FIG. 6 shows a plan view of a multilayer article according to the present invention, where the second substrate 2 has been introduced in a peripheral region of the longitudinal extent of the first substrate 1. This view likewise shows the reverse side of a first substrate 1; the cold-seal adhesive layer 3 here (depicted by the dotted area) has been applied only partially to the reverse side of the first substrate.

FIG. 7 schematically depicts the cross section through a multilayer article of the present invention, where the second substrate, depicted here by the second backing layer 6 and the cold-seal adhesive layer 4, as described above for FIG. 5, has been attached on the first substrate, depicted here by the first backing layer 5 and the cold-seal adhesive layer 3, and the multilayer article has then been positioned and fixed in the manner of a loop around an object 14, for example a luggage handle, via adhesive bonding of the two end regions of the cold-seal adhesive layer 3 of the first substrate. The arrangement here has the second substrate completely outside of the region in which a region of the cold-seal adhesive layer 3 of the first substrate has been adhesive-bonded to another region of said cold-seal adhesive layer 3.

FIG. 8 shows the corresponding arrangement obtained when a multilayer article as shown in FIG. 6 is arranged as described above for FIG. 7. The arrangement here has the second substrate completely within the region of those regions of the first substrate that have been bonded via regions of the cold-seal adhesive layer.

FIGS. 9 to 13 respectively show a plan view of a preferred embodiment of the article according to the invention in the form of an elongate baggage tag strip 10, which can have perforations (depicted by the broken lines) and which has stub sections and control sections (claim tag 11 and additional stubs 12) and also optionally peripheral regions 13 on the longitudinal side of the strip intended to improve transportability thereof within the printer, and optionally colored marking lines 15 prescribed by IATA for the identification of items of baggage on international flights.

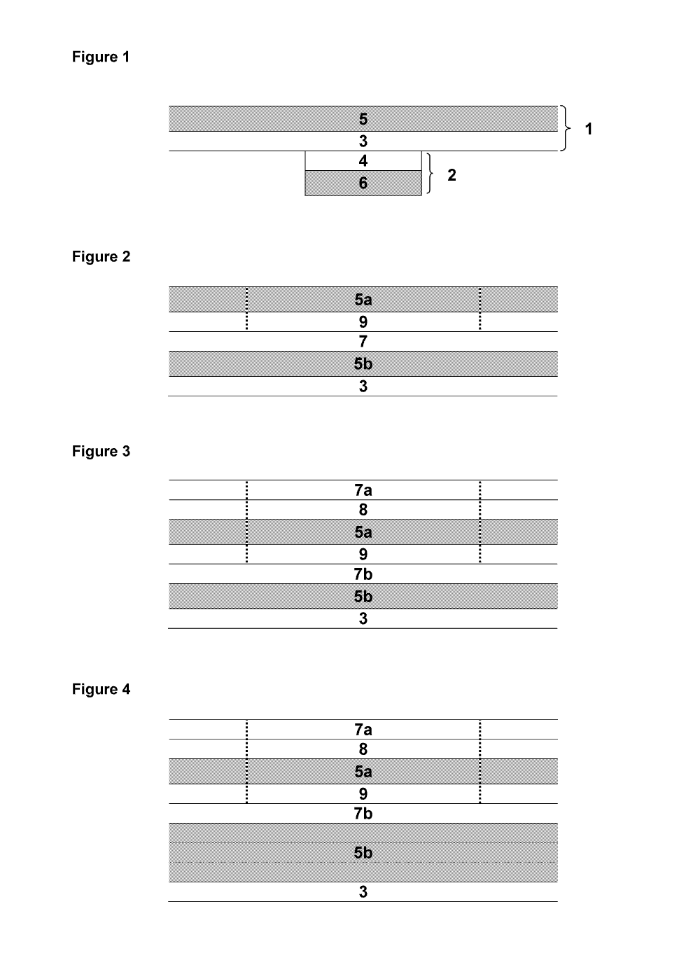

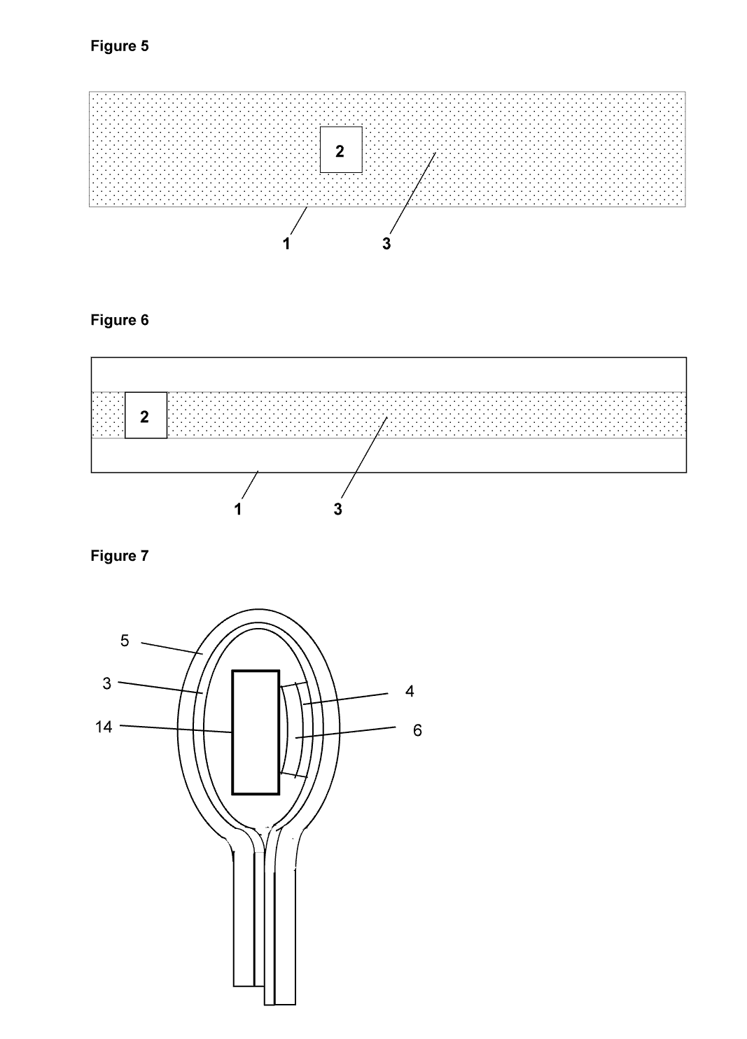

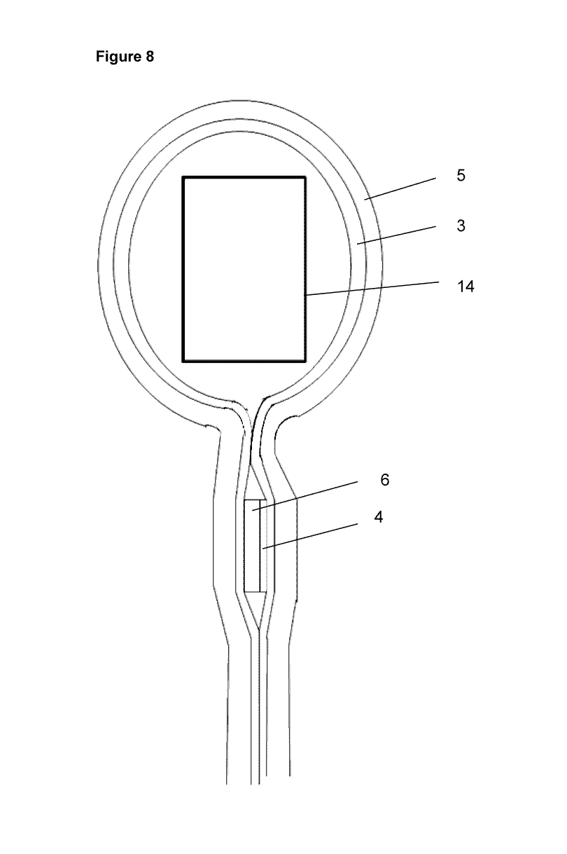

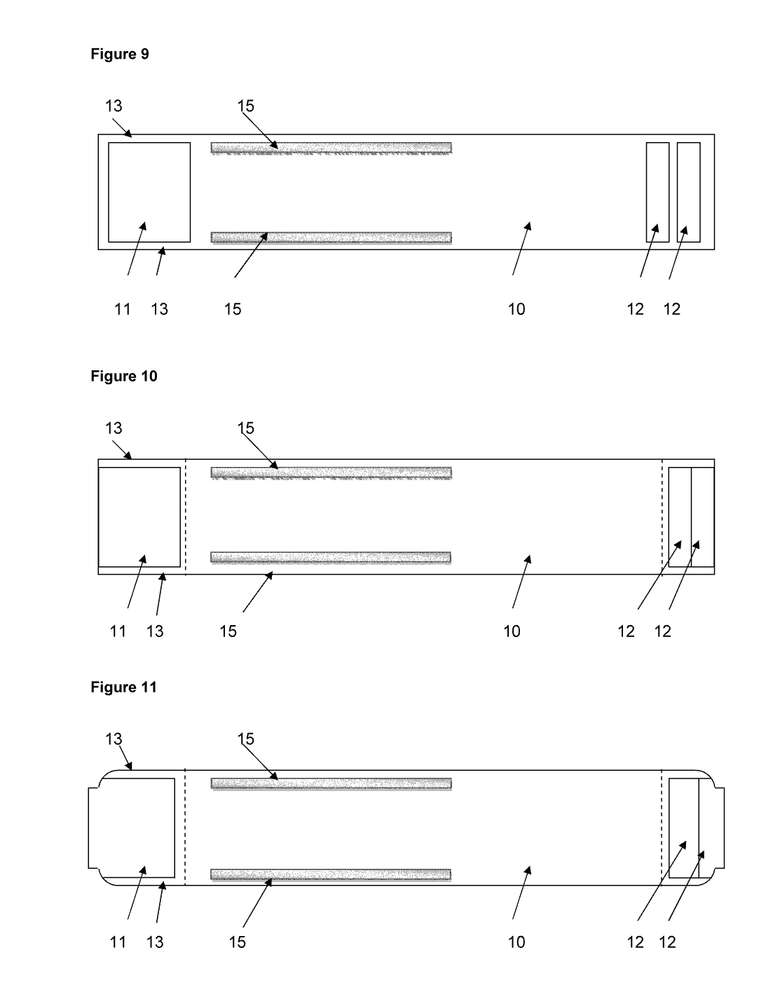

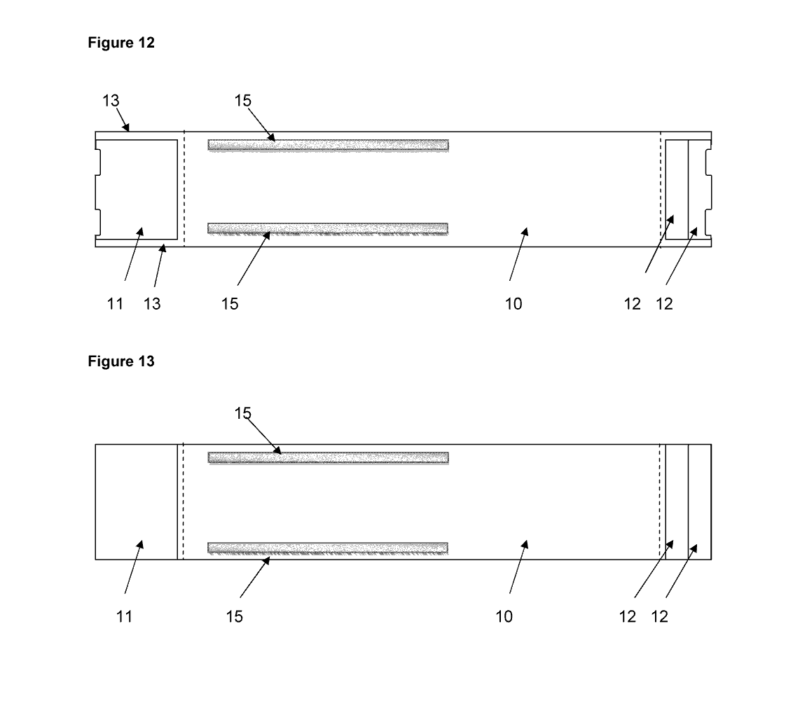

### DETAILED DESCRIPTION OF THE EXEMPLARY EMBODIMENTS

### Example 1

### Airline Baggage Tag According to the Invention with Cold-Seal Adhesive Coating and RFID Tag with Positioning of the RFID Tag in the Region of the Adhesive Bond of the Loop

The intention is that an airline baggage tag with RFID tag be printed out at check-in for a transfer flight with intermediate stop. Within the printer there are two unwind systems: in the first unwind system is the airline baggage tag measuring 485 mm in length and 52 mm in width and with the following product structure: heat-sensitive paper/pressure-sensitive adhesive/silicone layer/40 μm biaxially stretched polypropylene foil/lamination adhesive/30 g/m² paper/cold-seal adhesive layer. The pressure-sensitive adhesive used is a permanently adhesive hot-melt adhesive based on SIS (styrene-isoprene-styrene), and the lamination adhesive used is a self-crosslinking styrene-acrylate dispersion. The cold-seal adhesive used comprises 60% natural latex content, 30% tackifier content and 5 percent pigment content (calcium carbonate) and also 5 percent of other additives, such as wetting agents, antifoams, stabilizers etc. A suitable cold-seal adhesive is obtainable by way of example as Crodaseal 22-222 from Croda (Snaith, England).

In the second unwind system is a roll of RFID transponders using the frequency 13.56 MHz and measuring 30×30 or 45×35 mm² per RFID tag, and with the following product structure: polyester foil having frontal side printed or coated with an RFID antenna and an RFID chip, and reverse side coated with a cold-seal adhesive, together termed RFID tag.

Print-out of the airline baggage tag with RFID transponder begins by printing visually discernible information, such as barcode, departure airport and arrival airport, etc., onto the airline baggage tag located in unwind system 1. Toward the end of the print process, the RFID tag located in unwind system 2 is laminated thereto. The RFID tag is detached by cutting by way of a rotating blade from the remaining RFID tags located in unwind system 2, and its side coated with cold-seal adhesive is laminated within the printer to the likewise cold-seal-adhesive-coated side of the airline baggage tag, in such a way that the position of the external edge of the RFID tag is 30 mm prior to the end of the longitudinal side of the baggage tag. In parallel with the printing process, the RFID transponder is programmed with the desired information by way of the read/write equipment installed within the printer. The finished airline baggage tag with RFID transponder is detached by cutting by way of a second rotating blade positioned within the printer, or can be detached by tearing by the passenger, by means of perforation between the individual baggage tags.

The printed, detached airline baggage tag with RFID transponder is then positioned as loop tag around the luggage handle in the same way as a conventional airline baggage tag, and adhesive-bonded by way of the appropriate sections of the cold-seal adhesive layer.

The adhesions measured by a method based on FTM 1, as previously described above, were as follows: average adhesion of a baggage tag according to the invention with an area of 16 cm×5.2 cm adhesive-bonded by way of cold-seal adhesive with, located within the interior of said area, an RFID tag of length 45 mm and width 35 mm which has been coated only on one side with a cold-seal adhesive was about 11.3 N/52 mm.

The adhesion of a baggage tag without an RFID tag integrated into the adhesive-bonded area, with identical size and adhesive-bonded area, was about 15 N/52 mm.

It is therefore apparent that by using the structure according to the invention with cold-seal adhesive layers it is possible to achieve adequately high adhesion of the baggage tag even when an RFID tag has been integrated within the interior of the adhesive-bonded area and has been coated only on one side with cold-seal adhesive, and therefore provides no adhesion in this region between the two adhesive-bonded ends of the baggage tag.

### Example 2

### Standard Airline Baggage Tag with Pressure-Sensitive Adhesive Coating and Protective Silicone Paper Covering (Comparative Example)

For the same transfer flight, the intention is that a conventional airline baggage tag using pressure-sensitive adhesive and protective silicone paper covering with RFID tag be printed-out at check-in.

Use of an RFID tag with cold-seal adhesive coating is not possible, since this material does not adhere on the silicone paper reverse side of the airline baggage tag.

Although it is possible to achieve reverse-side application of an RFID tag by adhesive bonding by using a coating of pressure-sensitive adhesive, at least three winder devices are needed if this is to be possible “in-line” during the thermal printing process: unwind system 1 for the airline baggage tag material; unwind system 2 for the RFID tags and at least one third winder device for wind-up of the silicone paper of the RFID tag. Printers with at least three winder systems are not readily available commercially. Furthermore, a printer with at least three unwind systems incurs higher maintenance cost during use, is less reliable and is also more expensive.

### Example 3

### Airline Baggage Tag According to the Invention with Cold-Seal Adhesive Coating and RFID Tag with Positioning of the RFID Tag in the Region of the Loop

Again, the intention is that an airline baggage tag with RFID tag be printed out at check-in for a transfer flight at an airport. In the first of the two unwind systems of the printer is the airline baggage tag measuring 455 mm in length and 52 mm in width and with the following product structure: heat-sensitive paper/pressure-sensitive adhesive/silicone layer/30 μm biaxially stretched PLA foil/cold-seal adhesive layer.

In the second unwind system there are, by analogy with example 1, the RFID transponders measuring 30×30 or 45×35 mm² and with the following product structure: polyester foil having frontal side printed or coated with an RFID antenna and an RFID chip, and reverse side coated with a cold-seal adhesive.

Print-out of the airline baggage tag with RFID transponder begins by applying print to the substrate (airline baggage tag) located in unwind system 1. After 200 mm, the RFID tag located in unwind system 2 is laminated thereto. The RFID tag is detached by cutting by way of a rotating blade from the remainder of the RFID tags located in unwind system 2, and its cold-seal-adhesive-coated side is laminated to the likewise cold-seal-adhesive-coated side of the airline baggage tag. The finished airline baggage tag of length 485 mm with RFID transponder can be detached by tearing by the actual passenger by way of a perforation. When the airline baggage tag is adhesive-bonded around the luggage handle, an adhesive-bonded area of 160-200×52 mm² can be obtained without integrating the RFID transponder into the area that requires adhesive bonding.

### KEY

1 First substrate
2 Second substrate
3 Cold-seal adhesive layer of first substrate
4 Cold-seal adhesive layer of second substrate
5 Backing layer of first substrate (first backing layer)
6 Backing layer of second substrate (second backing layer)
7 Layer comprising release agent
8 Additional printable layer
9 Self-adhesive layer
10 Elongate, essentially rectangular strip as first substrate
11 Baggage stub for passenger (claim tag)
12 Control sections for airline (additional stubs)
13 Peripheral regions not cut or punched in order to improve transportability of substrate into printer
14 Object requiring identification marking or part of same, for example luggage handle
15 Colored marking lines

What is claimed is:

1. A multilayer article comprising:
a first substrate with a first backing layer; and
at least one further (second) substrate with a second backing layer,
wherein the first and the at least one further substrate are provided on respectively one side at least to some extent with a cold-seal adhesive layer and have been bonded to one another specifically via a contact between their respective cold-seal adhesive layers, where an area of the first substrate is greater than that of the at least one further substrate and the at least one further substrate only to some extent covers the cold-seal adhesive layer of the first substrate.

2. The article according to claim 1, wherein the second substrate comprises at least one chip for the storage of data and one antenna.

3. The article according to claim 1, wherein the second substrate comprises an RFID device.

4. The article according to claim 1, wherein the first and/or the second backing layer comprises a material selected from the group consisting of paper, paper board, polymer foils, metallized foils, metal foils, and nonwovens, or multilayer laminates comprising one or more of said materials, where individual layers of said multilayer laminates can respectively comprise same or different materials and can optionally have reinforcement by natural or synthetic fiber materials.

5. The article according to claim 4, wherein the polymer foils are selected from the group consisting of cellulose acetate (CA), polyamide (PA), polycarbonate (PC), polyethylene (PE), polyethylene naphthalate (PEN), polyethylene terephthalate (PET), polyimide (PI), polylactic acid (PLA), polypropylene (PP), polystyrene (PS), and polyvinyl chloride (PVC).

6. The article according to claim 1, wherein the cold-seal adhesive layers mutually independently respectively comprise at least one cold-seal adhesive selected from the group consisting of naturally occurring or synthetic latex, naturally occurring or synthetic rubber, (meth)acrylate copolymers, and mixtures of these.

7. The article according to claim 1, wherein at least one side of one of the first and second substrates, or of both substrates, comprises a writable and/or printable surface.

8. The article according to claim 7, wherein the writable and/or printable surface is writable and/or printable by a process selected from the group consisting of thermal printing, ink-jet printing, transfer printing, laser printing, offset printing, flexographic printing, intaglio printing, and screen printing.

9. The article according to claim 1, wherein at least one of the substrates comprises a multilayer laminate which comprises at least one layer comprising a release agent (release layer).

10. The article according to claim 9 wherein said multilayer laminate further comprises at least one self-adhesive layer.

11. The article according to claim 1, wherein the article is a label.

12. The article according to claim 1, wherein the article is a loop tag label that is configured to to be attached on an object requiring identification marking.

13. The article according to claim 1, wherein the article is a label in the form of a baggage-tag strip to be attached in the manner of a loop on an item of baggage for self-check-in.

14. The article according to claim 1, wherein the first substrate has been arranged at least to some extent in the manner of a loop in a manner such that a first region of the cold-seal adhesive layer of the first substrate has been adhesive-bonded to a further region of the cold-seal adhesive layer of said first substrate, and wherein the location of the second substrate can be outside of, to some extent within, or completely within said adhesive-bonded region.

15. The article according to claim 1, wherein the article is a label (loop tag) attached on the object requiring identification marking.

16. The article according to claim 1, wherein the article is a label attached in the manner of a loop in the form of a baggage-tag strip on an item of baggage.

17. The article according to claim 1, where the length of the first substrate is 150 to 800 mm, and/or its width is from 15 to 80 mm, and/or the length of the second substrate is 10 to 100 mm, and/or its width is 10 to 75 mm, where the second substrate is always shorter than the first substrate.

18. The article according to claim 17, wherein the second substrate is always narrower than the first substrate.

19. A process for producing the article according to claim 1, comprising:
separating provision of the first substrate and of the second substrate;
optionally cutting-to-size and/or segmenting the first substrate and/or of the second substrate;
positioning the second substrate relative to the first substrate in a manner such that the respective sides that have the cold-seal adhesive layer on the two substrates face each other; and
exerting a pressure on an arrangement obtained in the previous positioning step from the two substrates, in order to bond the first and second substrates to one another by way of their cold-seal adhesive layers.

20. The process according to claim 19, further comprising:
writing and/or printing onto at least one part of the surface of the first and/or second substrate.

21. The process according to claim 20, wherein said writing and/or printing is done onto at least one part of the surface of the first and/or second substrate that is opposite to the cold-seal adhesive layer.

22. The process of according to claim 20, wherein said writing and/or printing is done by means of a process selected from the group consisting of thermal printing, ink-jet printing, transfer printing, laser printing, offset printing, flexographic printing, intaglio printing, and screen printing, prior to or after the bonding of the at least two substrates.

23. The process according to claim 19, wherein the first substrate and/or the second substrate respectively is provided in the form of a web on a roll, and the substrate webs can mutually independently optionally have perforations.

24. The process according to claim 22, wherein the substrate webs is provided in a printer which comprises at least two unwind systems and at least one cutting device.

25. The process according to claim 24, wherein the printer is a thermal printer used for self-check-in.
